(19) United States
(12) Patent Application Publication
(10) Pub. No.: US 2025/0246330 A1
(43) Pub. Date: Jul. 31, 2025

(54) PACKAGE COMPRISING PACKAGING FOR TRANSPORTING AND/OR STORING RADIOACTIVE CONTENT COMPRISING A COMPACT INTERNAL SHOCK-ABSORPTION SYSTEM

(71) Applicant: ORANO NUCLEAR PACKAGES AND SERVICES, MONTIGNY-LE-BRETONNEUX (FR)

(72) Inventors: Mathieu ALONSO, ORANGE (FR); Clément BOSONE, SABLET (FR); Kelly POTTIER, VOISINS-LE-BRETONNEUX (FR); Michel SOLLACARO, LAUDUN L'ARDOISE (FR); Juliette VUONG, BAGNOLS SUR CEZE (FR); Axel ANICET, LAUDUN L'ARDOISE (FR)

(21) Appl. No.: 18/854,325

(22) PCT Filed: Mar. 31, 2023
(86) PCT No.: PCT/FR2023/050467

§ 371 Date: Oct. 4, 2024

(30) Foreign Application Priority Data
Apr. 5, 2022 (FR) FR2203105

(51) Int. Cl. G21F 5/08; B65D 81/107

(52) U.S. Cl. CPC G21F 5/08; B65D 81/107

(57) ABSTRACT

A package comprising radioactive content and packaging for transporting and/or storing the content, the packaging comprising an internal shock-absorption system housed in the confinement chamber between the radioactive content and an axial blocking member of the chamber, the radioactive content comprising a storage device and one or more radioactive elements. The internal shock-absorption system comprises a first shock-absorption device for absorption by plastic deformation in order to provide shock absorption for the storage device, and a second shock-absorption device for absorption by plastic deformation associated with a radioactive assembly formed of one or more radioactive elements, the first and second shock-absorption devices being designed to operate independently of each other and to take account of the maximum decelerations that can be withstood by the storage device and the radioactive elements accommodated in the device.

### TECHNICAL FIELD

The present invention relates to the field of packages for radioactive materials, comprising a packaging as well as a radioactive content accommodated in a confinement chamber defined by the packaging.

The packaging may be of the type comprising a removable cover, such as for example used for transporting nuclear fuel assemblies. Alternatively, it may consist of a case or container type packaging, in which the cover is preferably permanently fastened on the packaging lateral body, for example by welding.

In the confinement chamber delimited by the packaging, the radioactive content comprises a storage device as well as one or more radioactive element(s), these could be nuclear fuel assemblies, vitrified wastes or technological wastes containers/cases, shells and nozzles containers/cases, or cases for transporting powder (for example PuO2 powder).

More specifically, the invention relates to an internal shock-absorption system, accommodated axially in the confinement chamber between the radioactive content and an axial blocking member of the package, namely its cover or its bottom. In this respect, it should be noted that such a shock-absorption system is preferably associated with the cover of the packaging to protect the integrity of the confinement chamber in the event of an axial fall of the package. Nevertheless, such an internal shock-absorption system may simultaneously, or alternatively, be provided in association with the bottom of the packaging.

### PRIOR ART

A package for storing and/or transporting radioactive materials generally includes, as a sealed external casing, a packaging having a lateral body, a bottom and a cover. These portions of the packaging define a cavity, so-called confinement chamber, for accommodating a radioactive content, for example formed by a storage device accommodating nuclear fuel assemblies. The storage device is usually so-called storage basket. It includes one or more axial compartment(s) each intended to accommodate a radioactive element, namely a nuclear fuel assembly in the example given hereinabove. In another case where the radioactive elements consist of cases and/or containers, several of them could be stacked axially in each compartment of the storage basket.

The demonstration of safety of the packaging loaded with the radioactive content is based in particular on regulatory fall tests. Thus, during a nine-metre axial fall on a head damper cover covering the cover of the packaging, the radioactive content could move axially in the cavity of the packaging towards the cover because of a functional clearance between the radioactive content and the cover. While the head damper cover is crushed, the radioactive content could then impact this same cover during this fall so-called “axial fall”. Thus, very significant loads are generated in retardation in the closure system of the removable cover of the packaging, under the effect of the radioactive content accommodated in the confinement chamber. In particular, the device for fastening the cover is substantially loaded, the latter could, for example, be made using fastening screws, or comprise a bayonet ring.

In order to ensure tightness of the packaging after the axial fall, it might prove necessary to limit the loads transmitted by the radioactive content on the cover, by means of an internal shock-absorption system placed in the confinement chamber, between the cover and the radioactive content. The system is also so-called internal shock-absorption system. In general, such a system includes one or more damping devices by plastic deformation, like metal foam. To obtain optimum crushing of each damping device, and therefore to best dissipate the mechanical energy throughout the plastic deformation of each damping device, many solutions have already been proposed in the previous embodiments.

Among the design criteria of the internal shock-absorption system, the maximum decelerations that the storage basket, on the one hand, and the radioactive elements accommodated in this basket, on the other hand, might withstand. Usually, it is the lowest maximum deceleration of the two which is retained for the design of the shock absorber, in addition to other criteria like the need to absorb all of the potential energy of the radioactive content in the event of axial fall, without the risk of bumping of the shock-absorption system, or the need to limit the loads transmitted by the radioactive content on the device for fastening the cover.

By taking account of the lowest acceptable maximum deceleration, this could induce a significant oversizing of the internal shock-absorption system and of the entirety of the packaging, in particular in the axial direction. Consequently, there is still a need to improve these internal shock-absorption systems, so as to offer a better trade-off in terms of bulk, costs and performances.

Finally, it should be noted that this problem also exists for an internal shock-absorption system associated with a non-removable packaging cover, like a welded case cover, or for an internal shock-absorption system associated with the packaging bottom, generally non-removable too. In these two cases, even though there is no problem of holding of the fastening device of the closure system like for a removable cover, maximum decelerations in the event of an axial fall on the non-removable cover/bottom side also need to be taken into account in some situations.

### DISCLOSURE OF THE INVENTION

To address this need identified hereinabove, an object of the invention is a package comprising radioactive content as well as a packaging for transporting and/or storing this content, the packaging comprising a lateral body extending around a longitudinal central axis of the packaging, as well as a bottom and a cover respectively arranged at the axial ends of the packaging lateral body and forming two axial blocking members delimiting, with the packaging lateral body, a confinement chamber in which the radioactive content is accommodated, the packaging also including an internal shock-absorption system accommodated in the confinement chamber and arranged axially between the radioactive content and one of the two axial blocking members, so-called the associated axial blocking member, the radioactive content comprising a storage device as well as one or more radioactive element(s), the storage device delimiting one or more axial compartment(s) axially open in the direction of the associated axial blocking member, and in each of which at least one radioactive element is arranged.

According to the invention, the internal shock-absorption system includes a first damping device by plastic deformation for damping the storage device, and a second damping device by plastic deformation associated with a radioactive assembly formed of one or more radioactive element(s),
the first and second damping devices being arranged so as to operate independently of each other in the event of an axial fall of the package,
the first damping device being associated with the following first parameters:
   σ₁, corresponding to the crushing stress of this first damping device;
   S₁, corresponding to the active surface of the first damping device intended to be axially impacted by the storage device in the event of an axial fall of the package;
   M₁, corresponding to the mass of the storage device intended to be damped by the first damping device;
   γ₁, corresponding to a first value representative of the deceleration of the storage device in the event of an axial fall of the package leading to this storage device plastically crushing the first damping device, the first deceleration representative value γ₁ being determined by the following formula: γ₁=(σ₁*S₁)/M₁,
the second damping device being associated with the following second parameters:
   σ₂, corresponding to the crushing stress of this second damping device;
   S₂, corresponding to the active surface of the second damping device intended to be axially impacted by its associated radioactive assembly, in the event of an axial fall of the package;
   M₂, corresponding to the mass of the radioactive assembly intended to be damped by the second damping device;
   γ₂, corresponding to a second value representative of the deceleration of the associated radioactive assembly, in the event of an axial fall of the package leading to this radioactive assembly plastically crushing the second damping device, the second deceleration representative value γ₂ being determined by the following formula: γ₂=(σ₂*S₂)/M₂,
the first and second parameters are such that the second deceleration representative value γ₂ is different from the first deceleration representative value γ₁.

The invention allows having an effective internal shock-absorption system, having a satisfactory compactness. This compactness is enhanced in comparison with the embodiments of the prior art, thanks to the consideration of a differentiated maximum acceptable deceleration on the one hand for the storage device and, on the other hand, for the radioactive assembly formed of one or more radioactive element(s), like one or more nuclear fuel assemblies, and preferably one single assembly.

Thus, each of the independent damping devices may be designed as small as possible, in order to improve the compactness of the whole. In other words, the invention is built on the basis of the observation that the radioactive elements could withstand higher decelerations than the storage device that accommodates them, or vice versa. Hence, the second associated damping device could have a higher crushing stress, or a larger active surface area, and therefore adopt a smaller axial height synonymous of a reduction in bulk and of greater compactness. These advantageous measurements could be adopted while complying with the maximum acceptable deceleration for the radioactive elements, and while being capable of absorbing all of the potential energy of these, without the risk of bumping of the second damping device.

Preferably, the invention provides for the implementation of one or more of the following optional features, considered separately or in combination.

Preferably, the ratio |γ₂−γ₁|/min (γ₂, γ₁) is higher than 1.1.

Preferably, the internal shock-absorption system has one or more other second damping device(s) by plastic deformation, each associated with a distinct radioactive assembly formed of one or more other radioactive element(s), the first and second parameters of the first and second damping devices are such that the second deceleration representative value γ₂ associated with each of at least several second devices damping device, and preferably with each of all of these second damping devices, is different from the first deceleration representative value γ₁ associated with the first damping device.

Preferably, the radioactive assembly associated with the second damping device, or with each second damping device, is formed of one single radioactive element.

Preferably, each radioactive element is a nuclear fuel assembly, preferably a fresh fuel assembly, still more preferably of the MOX type, or a vitrified wastes or technological wastes container/case, or a shells and nozzles container/case, or a case for transporting powder.

Preferably, the or each second damping device is formed of one single damping material block, preferably made of metal foam, wood, honeycomb or using a metal tubular structure. Alternatively, each second damping device may comprise several blocks spaced apart from one another and operating independently in the event of an axial fall of the package. In any case, for damping of the radioactive elements, all of the blocks preferably have the same crushing stress.

Preferably, the first damping device is formed of several damping material blocks spaced apart from one another, preferably made of foam, wood, honeycomb or using a metal tubular structure. Preferably, all of these damping blocks associated with the storage device have the same crushing stress. Alternatively, the first damping device could be formed of one single damping material block.

Preferably, the aforementioned blocks are cylindrical, or have a pyramidal shape.

Preferably, the crushing stress σ₂ of the or each second damping device is different from the crushing stress σ₁ of the first damping device. Alternatively, identical crushing stresses may be retained for the first and second damping devices, without departing from the scope of the invention. In this case, the differentiated decelerations of the entities are controlled by the extent of the active surfaces of the first and second damping devices, or by the masses of the storage device and of each radioactive assembly.

Preferably, the first damping device and the or each second damping device all have an identical or substantially identical axial thickness. For example, a variation in the thickness in the range of 10% at most can be tolerated between the highest value, and the lowest value.

Preferably, the first damping device and the or each second damping device are arranged in the same transverse plane of the package.

Preferably, the first damping device and the or each second damping device are arranged in the same casing.

Preferably, the storage device includes an apertured head plate, and the internal shock-absorption system is preferably fastened on said apertured head plate. Alternatively, the internal shock-absorption system may be fastened on the associated axial blocking member, for example the cover of the packaging, or simply be arranged freely between the storage basket and this associated axial blocking member.

Preferably, the associated axial blocking member is the cover of the packaging, preferably removably mounted on the packaging lateral body. Alternatively, the associated axial blocking member is the bottom of the packaging. Indeed, even though there is no problem of holding of the screws of the closure system on the bottom side, the control of the decelerations in the event of an axial fall on the bottom side could also be to be taken into account in some situations.

Other advantages and features of the invention will appear in the non-limiting detailed description hereinbelow.

### BRIEF DESCRIPTION OF THE DRAWINGS

This description will be made with reference to the appended drawings, wherein:

FIG. 1 shows a schematic axial sectional view of a package according to a preferred embodiment of the present invention;

FIG. 2 shows a perspective view of the radioactive content shown in the previous figure, according to a preferred embodiment of the invention;

FIG. 3 is a perspective view of the internal shock-absorption system equipping the package shown in FIG. 1;

FIG. 4 shows an exploded perspective view of the internal shock-absorption system shown in the previous figure;

FIG. 5 shows a perspective view of the internal shock-absorption system similar to that of FIG. 3, with one of the two half-casing which has been removed for clarity;

FIG. 6 is a cross-sectional view of the internal shock-absorption system, taken according to the plane P of FIG. 5, passing through the ends of the damping blocks; and

FIG. 7 shows a sectional view taken along the line VII-VII of FIG. 6.

### DESCRIPTION OF THE EMBODIMENTS

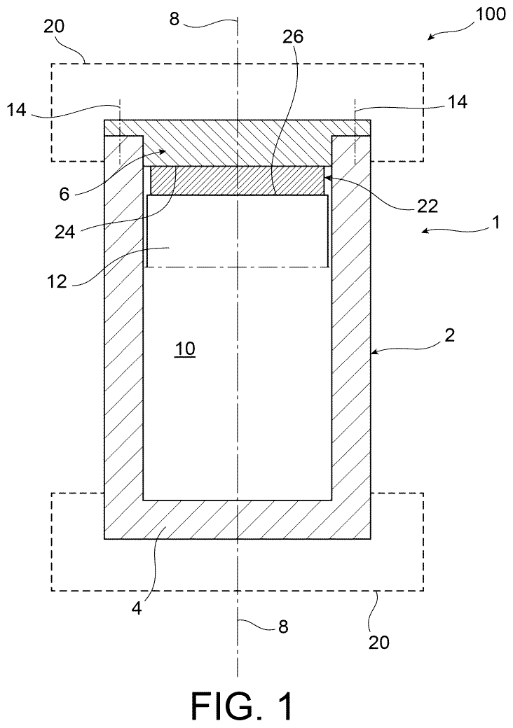

Referring at first to FIG. 1, a package 100 for storing and/or transporting a radioactive content 12 is shown, in the form of a preferred embodiment of the present invention. First of all, the package 100 includes a packaging 1 provided with a lateral body 2, a bottom 4 and a removable cover 6 sealing an opening of the packaging opposite to the bottom 4. The packaging has a longitudinal central axis 8 around which the lateral body 2 extends, this axis 8 passing through the cover 6 and the bottom 4 respectively arranged at the front and rear ends of the packaging lateral body 2. As schematically illustrated in FIG. 1, the bottom 4 may be made in one-piece with the packaging lateral body 2. In turn, the cover 6 is affixed on the front end of the lateral body 2, corresponding to the high end in the vertical position of the packaging shown in FIG. 1. Preferably, fastening of the cover 6 is done using screwed elements 14, distributed at the periphery of the cover.

The lateral body 2, the cover 6 as well as the bottom 4 delimit a confinement chamber 10 used for accommodating the radioactive content 12. Thus, the cover 6 and the bottom 4 form the two opposite axial blocking members of the confinement chamber 10.

The radioactive content 12, also centred on the axis 8, comprises a storage device and one or more radioactive element(s), herein nuclear fuel assemblies, preferably fresh fuel such as MOX fuel. Instead of the nuclear fuel assemblies, the radioactive elements in the context of the invention could alternatively consist of vitrified wastes containers/cases, shells and nozzles containers/cases, or cases for transporting powder. In these alternative examples, the containers/cases accommodated in the storage device are also sealed.

As shown in dotted lines in FIG. 1, at the ends of the package considered according to the direction of the axis 8, the packaging may be equipped with damper cowls 20 respectively protecting the removable cover 6 and the bottom 4 of the packaging.

The packaging 1 is also equipped with an internal shock-absorption system 22 specific to the invention, illustrated only schematically in FIG. 1. This internal shock-absorption system 22 is accommodated in the confinement chamber 12, axially between an inner surface 24 of the cover 6, and an axial end surface 26 of the radioactive content 12. Preferably, the internal shock-absorption system 22 is fastened on the axial end surface 26 of the radioactive content 12, for example using screwed elements or by welding. It could alternatively be fastened on the inner surface 24 of the cover 6, or freely arranged between the radioactive content 12 and the cover 6.

Thus, the internal shock-absorption system 22 may be arranged in several ways between the radioactive content 12 and its associated axial blocking member, formed by the removable cover 6.

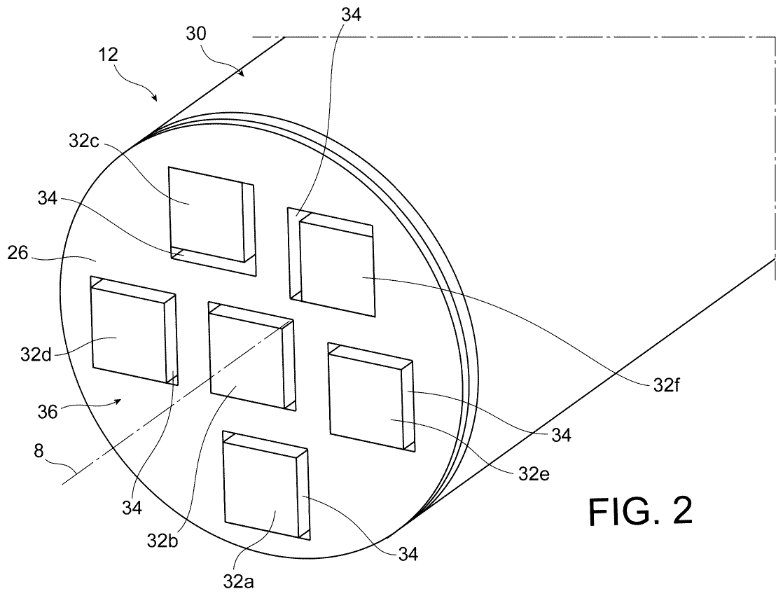

Referring now to FIG. 2, the radioactive content 12, comprising the storage device/basket 30 and the nuclear fuel assemblies 32a-32f, is shown. Each of these assemblies 32a-32f is arranged in a compartment 34 defined by the basket 30. The compartments 34 are open axially at an apertured head plate 36 of the basket, on which the internal shock-absorption system is intended to be fastened. Thus, because of its apertured nature, the head plate 36 forms the axial end of the compartments 34. Thus, the axial end surface 26 of the radioactive content 12 is formed by the planar external surface of the head plate 36, and by the axial end surface of the assemblies 32a-32f located close to or in the same plane as the planar external surface of the head plate 36.

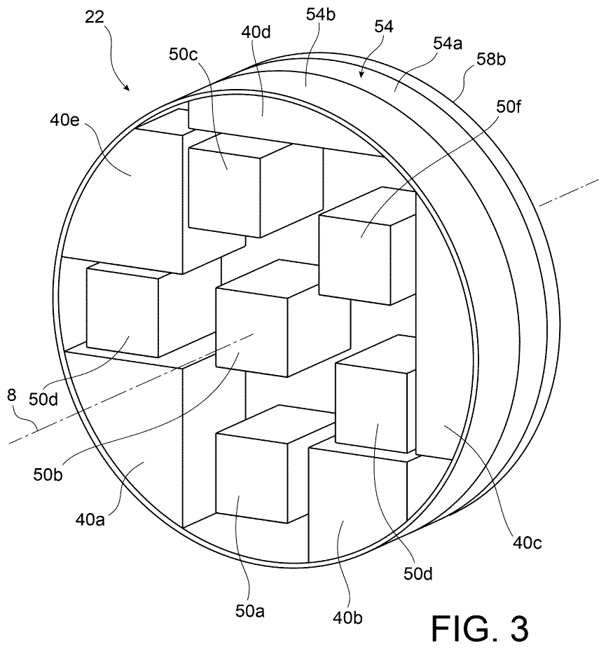

One of the particularities of the invention lies in the dissociation and independence of the means used to dampen, on the one hand, the basket 30 and, on the other hand, each of the assemblies 32a-32f, in the event of an axial fall of the package on the cover side. This particularity will now be described with reference to FIGS. 3 to 7, showing the internal shock-absorption system 22 which generally includes a first damping device by plastic deformation for damping the basket 30, as well as a second damping device by plastic deformation associated with each of the assemblies 32a-32f. In this preferred embodiment, each nuclear fuel assembly 32a-32f thus forms, in the context of the claimed invention, a radioactive assembly composed of one single radioactive element (the assembly as such).

The first damping device 40 is herein formed of several cylindrical blocks 40a-40e distributed at the periphery of the generally cylindrical shaped shock-absorbing system 22, and centred on the axis 8. Thus, each of the blocks 40a-40e is cylindrical with an axis orthogonal or substantially orthogonal to the planar external surface 26 of the head plate 36, in the direction of which these blocks are directed. These are spaced apart from one another, and they are preferably made of foam, wood, honeycomb or using a metal tubular structure, preferably with the same crushing stress σ₁ (in MPa).

The active surface S₁ (in m²) of the first damping device 40 corresponds to the surface of the blocks 40a-40e intended to be impacted axially by the planar external surface 26 of the head plate 36, in the event of an axial fall of the package. More specifically, this active surface S₁ corresponds to the addition of the active surfaces S₁ₐ-S₁ₑ of all of the blocks 40a-40e forming the first damping device 40. These surfaces S₁ₐ-S₁ₑ correspond to the lower axial ends of the blocks 40a-40e, and all of them are, quite preferentially, planar or substantially plane, orthogonal or substantially orthogonal to the axis 8, and coplanar. In case of non-flatness of these lower axial ends of the blocks 40a-40e, each active surface S₁ₐ-S₁ₑ then corresponds to the projected surface of the lower axial end of the considered block, in a plane orthogonal to the axis 8, and according to the direction of this same axis. Also, because of the cylindrical nature of the block, each active surface S₁ₐ-S₁ₑ also corresponds, in terms of dimension and shape, to any cross-section of its corresponding block 40a-40e. Alternatively, the blocks could have a pyramidal shape, the active surfaces could then vary according to the thickness of the block and thus generate lower decelerations at the beginning of the impact. In this case, the general principle of the invention according to which the first and second parameters are such that the second deceleration representative value γ₂ is different from the first deceleration representative value γ₁, is complied with at all times during an axial fall of the package leading to the radioactive assembly plastically crushing the first and second damping devices.

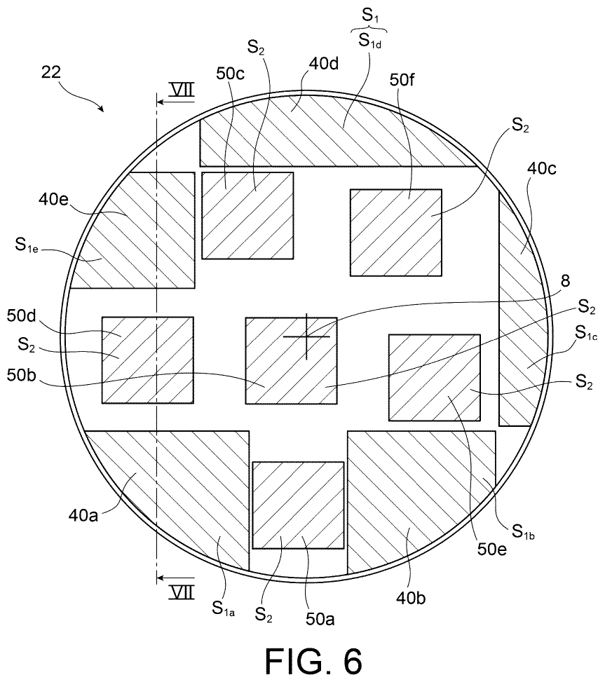

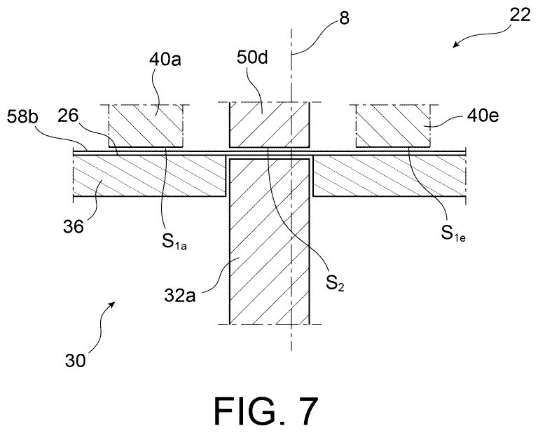

These active surfaces are schematically shown in the section of FIG. 6 taken in the plane of these surfaces or substantially closer, orthogonally to the axis 8, and also visible in part in FIG. 7.

The mass M₁ (in kg) corresponding to the mass of the basket 30 intended to be damped by the first damping device 40.

Thus, using the aforementioned parameters relating to this first damping device 40, the value of γ₁ is determined, corresponding to a first value representative of the deceleration of the basket 30 in the event of an axial fall of the package leading to this basket plastically crushing the first damping device 40. This first deceleration representative value γ₁ is determined by the following formula: γ₁=(σ₁*S₁)/M₁.

As indicated before, the internal shock-absorption system 22 also includes several second damping devices 50a-50f, each associated with one of the assemblies 32a-32g for damping it in the event of an axial fall of the package. Thus, the second damping devices 50a-50f are independent of each other, and also independent of the blocks of the first damping device 40. This results in that, in the event of an axial fall of the package, each of these elements deforms plastically in a free manner, without being hindered by the deformation of the other elements located at a distance. This independence of the blocks during crushing thereof is obtained in particular because of the absence of a plate for distributing the loads which is found in some solutions of the prior art, and which is usually arranged between the shock-absorption systems and the radioactive content.

In this preferred embodiment of the invention, all of the second damping devices 50 are identical, therefore only one of them will be described in detail hereinafter.

Each second damping device is herein formed of one single cylindrical block 50a-50f, the blocks being distributed at the periphery and at the centre of the shock-absorption system 22, according to the same distribution as that of the assemblies 32a-32f. Thus, the blocks 50a-50f are cylindrical with axes orthogonal or substantially orthogonal to the planar external surface 26 of the head plate 36, as well as to the axial end surface of the nuclear fuel assemblies in the direction of which these blocks 50a-50f are directed, respectively. The blocks 50a-50f are spaced apart from one another, and also spaced apart from the blocks of the first damping device 40. Preferably, they are made of foam, wood or honeycomb, preferably with the same crushing stress σ₂ (in MPa), itself preferably different from the aforementioned crushing stress σ₁.

The active surface S₂ (in m²) of each second damping device 50a-50f corresponds to the surface of the block intended to be located axially bearing against the axial end surface of the associated assembly 32a-32f, in the event of an axial fall of the package. Hence, this surface S₂ is formed by the lower axial end of the damping block 50a-50f, which is quite preferentially planar or substantially planar, orthogonal or substantially orthogonal to the axis 8. Preferably, all of the active surfaces S₂ are also coplanar. In the case of non-flatness of this lower axial end of the damper block, the active surface S₂ then corresponds to the projected surface of the lower axial end of this block, in a plane orthogonal to the axis 8, and according to the direction of this same axis.

Also, because of the cylindrical nature of the block, the active surface S₂ also corresponds, in terms of size and shape, to any cross-section of its corresponding block 50a-50f. In axial view, this active surface S₂ also preferably corresponds, in terms of size and shape, to that of the axial end surface of the associated assembly 32a-32f, a perfect or almost-perfect match being actually looked for between these two surfaces, in the direction of the axis 8.

Nevertheless, the active surface S₂ could have a smaller or larger dimension, without departing from the scope of the invention.

The active surfaces S₂ are schematically shown in the section of FIG. 6 taken in the plane of these surfaces or substantially closer, orthogonally to the axis 8, and one of which is also visible in FIG. 7.

In turn, the mass M₂ (in kg) corresponds to the mass of each nuclear fuel assembly 32a-32f, intended to be damped by the second damping device 50a-50f located axially opposite thereto.

Thus, using the aforementioned parameters relating to each of these second damping devices 40, the value of γ₂ corresponding to a second value representative of the deceleration of each assembly 32a-32f is determined, in the event of an axial fall of the package leading to this assembly plastically crushing its associated second damping device, the second deceleration representative value γ₂ being determined by the following formula: γ₂=(σ₂*S₂)/M₂.

Thanks to the proposed design, the aforementioned first and second parameters are advantageously selected so that the second deceleration representative value γ₂ is different from the first deceleration representative value γ₁. In this respect, the ratio |γ₂−γ₁|/min (γ₂, γ₁) is preferably higher than 1.1.

This leads to a reduction in the overall size of the internal shock-absorption system 22, since the maximum acceptable deceleration for the basket 30, and that of each of the assemblies 32a-32f, often higher than that of the basket, are specifically taken into account. Thus, each of the independent damping devices 40, 50a-50f could be designed as small as possible, to improve the compactness of the whole.

The design is also retained by adapting the extent of the active surfaces S₁, S₂ so that all of the blocks 40a-40e, 50a-50f are located in the same transverse plane of the package, while having an identical or substantially identical axial thickness. Nevertheless, the blocks 50a-50f could alternatively comprise an axial thickness larger than that of the blocks 40a-40e by extending axially into the compartments of the basket while passing through the openings of the apertured head plate 36.

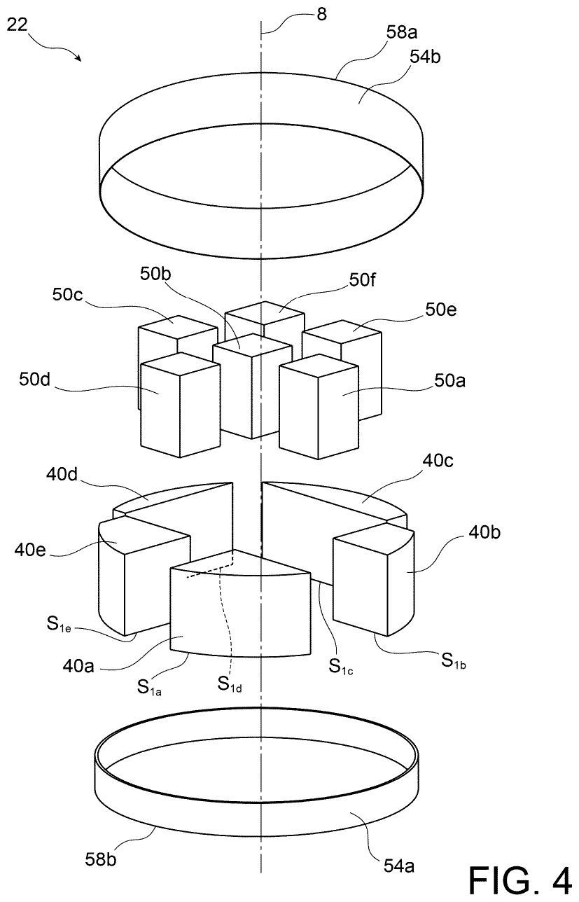

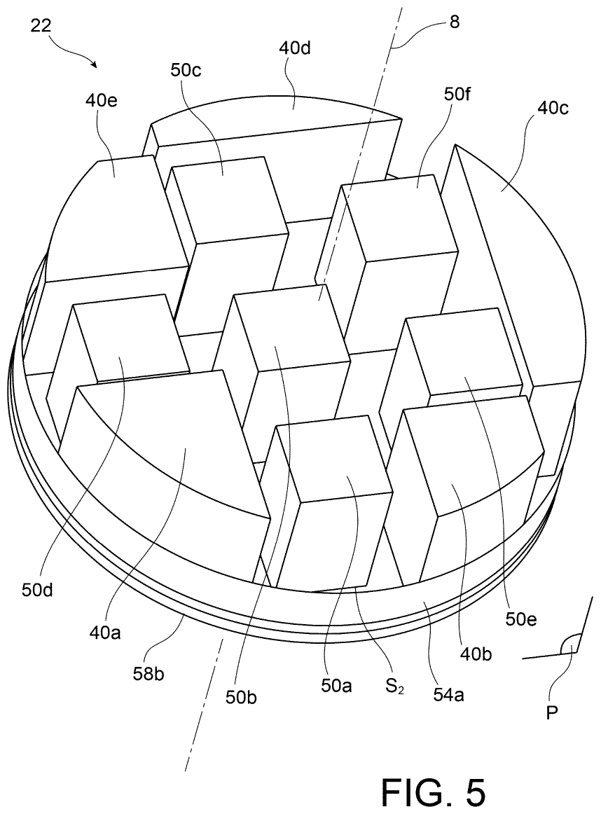

In the case of the first assumption, this allows in particular facilitating enclosing of these blocks 40a-40e, 50a-50f in the same generally cylindrical casing 54, shown in FIG. 3 and corresponding to an external casing of the internal shock-absorption system 22. This casing 54 may be made using two half-casings 54a, 54b welded at an axial median portion of the system 22 and closed at its two axial ends by two disk-like shaped plates 58a, 58b, these half-casings also being visible in FIGS. 4 and 5. It should be noted that on this casing 54, the closure plate 58b arranged opposite/in contact with the radioactive content remains thin, so as to keep the independence of operation of the different damping blocks by plastic deformation 40a-40e, 50a-50f. In other words, this plate 58b does not ensure any load distribution plate function in the event of an axial fall of the package. Inside the casing, the active surfaces S₁, S₂ of the blocks 40a-40e, 50a-50f are intended to be in contact with the internal surface of the plate 58b, even though axial clearances have been kept in the illustration of FIG. 7, for clarity.

Of course, various modifications could be made by a person skilled in the art to the invention that has just been described, merely as non-limiting examples and whose scope is defined by the appended claims. For example, the packaging 1 could include a non-removable cover, for example welded onto the packaging lateral body, so as to form a sealed case enclosing the basket and radioactive elements, this case being also so-called “canister”. Furthermore, the internal shock-absorption system according to the invention could be associated with the bottom 4 of the packaging, without departing from the scope of the invention.

1. A package comprising radioactive content as well as a packaging for transporting and/or storing this content, the packaging comprising a lateral body extending around a longitudinal central axis of the packaging, as well as a bottom and a cover respectively arranged at the axial ends of the packaging lateral body and forming two axial blocking members delimiting, with the packaging lateral body, a confinement chamber in which the radioactive content is accommodated, the packaging also including an internal shock-absorption system accommodated in the confinement chamber and arranged axially between the radioactive content and one of the two axial blocking members, so-called the associated axial blocking member, the radioactive content comprising a storage device as well as one or more radioactive element(s), the storage device delimiting one or more axial compartment(s) axially open in the direction of the associated axial blocking member, and in each of which at least one radioactive element is arranged,
wherein that the internal shock-absorption system includes a first damping device by plastic deformation for damping the storage device, and a second damping device by plastic deformation associated with a radioactive assembly formed of one or more radioactive element(s),
the first and second damping devices being arranged so as to operate independently of each other in the event of an axial fall of the package,
the first damping device being associated with the following first parameters:
σ₁, corresponding to the crushing stress of this first damping device;
S₁, corresponding to the active surface of the first damping device intended to be axially impacted by the storage device in the event of an axial fall of the package;
M₁, corresponding to the mass of the storage device intended to be damped by the first damping device;
γ₁, corresponding to a first value representative of the deceleration of the storage device in the event of an axial fall of the package leading to this storage device plastically crushing the first damping device, the first deceleration representative value γ₁ being determined by the following formula: γ₁=(σ₁*S₁)/M₁,
the second damping device being associated with the following second parameters:
σ₂, corresponding to the crushing stress of this second damping device;
S₂, corresponding to the active surface of the second damping device intended to be axially impacted by its associated radioactive assembly, in the event of an axial fall of the package;
M₂, corresponding to the mass of the radioactive assembly intended to be damped by the second damping device;
γ₂, corresponding to a second value representative of the deceleration of the associated radioactive assembly, in the event of an axial fall of the package leading to this radioactive assembly plastically crushing the second damping device, the second deceleration representative value γ₂ being determined by the following formula: γ₂=(σ₂*S₂)/M₂,
and in that the first and second parameters are such that the second deceleration representative value γ₂ is different from the first deceleration representative value γ₁.

2. The package according to claim 1, wherein the ratio |γ₂−γ₁|/min (γ₂, γ₁) is higher than 1.1.

3. The package according to claim 1, wherein the internal shock-absorption system has one or more other second damping device(s) by plastic deformation, each associated with a distinct radioactive assembly formed of one or more other radioactive element(s),
and in that the first and second parameters of the first and second damping devices are such that the second deceleration representative value γ₂ associated with each of at least several second devices damping device, and preferably with each of all of these second damping devices, is different from the first deceleration representative value γ₁ associated with the first damping device.

4. The package according to claim 1, wherein the radioactive assembly associated with the second damping device, is formed of one single radioactive element.

5. The package according to claim 1, wherein each radioactive element is a nuclear fuel assembly, preferably a fresh fuel assembly, still more preferably of the MOX type, or a vitrified wastes container/case, or a shells and nozzles container/case, or a case for transporting powder.

6. The package according to claim 1, wherein the second damping device is formed of one single damping material block, preferably made of metal foam, wood, honeycomb, or using a metal tubular structure.

7. The package according to claim 1, wherein the first damping device is formed of several damping material blocks spaced apart from one another, preferably made of foam, wood, honeycomb or using a metal tubular structure.

8. The package according to claim 1, wherein the crushing stress σ₂ of the second damping device is different from the crushing stress σ₁ of the first damping device.

9. The package according to claim 1, wherein the first damping device and the each second damping device all have an identical or substantially identical axial thickness.

10. The package according to claim 1, wherein the first damping device and the second damping device are arranged in the same transverse plane of the package.

11. The package according to claim 1, wherein the first damping device and the second damping device are arranged in the same casing.

12. The package according to claim 1, wherein the storage device includes an apertured head plate, and in that the internal shock-absorption system is preferably fastened on said apertured head plate.

13. The package according to claim 1, wherein the associated axial blocking member is the cover of the packaging, removably mounted on the packaging lateral body.
